(19) United States
(12) Patent Application Publication
(10) Pub. No.: US 2004/0075697 A1
(43) Pub. Date: Apr. 22, 2004

(54) Apparatus, system, method, and program for using GIS data

(76) Inventor: Matthew Eric Maudlin, Brownsburg, IN (US)

Correspondence Address: BARNES & THORNBURG, 11 SOUTH MERIDIAN, INDIANAPOLIS, IN, 46204

(21) Appl. No.: 10/271,910

(22) Filed: Oct. 16, 2002

(51) Int. Cl. G09G 5/00

(52) U.S. Cl. 345/848

(57) ABSTRACT

An apparatus, system, method, and program for using GIS data include a three-dimensional model of an architectural structure for presenting the GIS data to a user. When the user selects a portion of the three-dimensional model, GIS data associated with the selected portion is retrieved from a GIS database and displayed to the user. In a specific implementation, a three-dimensional model is displayed on a client machine of the user, and the GIS database is maintained on a server machine. As such, the GIS data desired by the user is retrieved across a network such as a global network (e.g., the internet).

### FIELD OF THE DISCLOSURE

The present disclosure relates generally to a network-based GIS system, and more particularly to a three-dimensional model for use with a network-based GIS system.

### BACKGROUND OF THE DISCLOSURE

Graphic Information Systems (GIS) are systems that provide information about not only the location of items such as buildings, streets, sewers, lamp posts, etcetera, but also information about the items themselves. Indeed, unlike a typical map, where only the location of items are displayed, a GIS map provides “layers” of information. In other words, a GIS map combines layers of information about a given item or location thereby providing the user with a better understanding of that place.

As with a typical map, a map created with GIS data includes indicia such as dots or points that represent features on the map such as cities; lines that represent features such as roads; and small areas that represent features such as lakes. However, unlike a typical map, such information comes from a GIS database and is shown only if the user chooses to show it. The GIS database stores where the point is located, how long the road is, and even how many square miles a lake occupies. Each piece of information in the map sits on a layer, and the user may turn on or off any layer to fit their needs. One layer could be made up of all the roads in an area. Another could represent all the lakes in the same area. Yet another could represent all the cities.

Such layers may also take the form of, for example, a soil layer which demonstrates the soil characteristics of the land on which a building is constructed. Water supply, sewer, or electrical layers associated with a building may also be generated. Again, such layers of information may be selectively displayed or suppressed depending on the interests of the user. For example, layer GIS data may be used to find the best location for a new store, analyze environmental damage, view the location of the sprinkler heads or spigots associated with a fire suppression system, view similar crimes in a city to detect a pattern, and so on.

As a result, use of GIS data has a number of advantages. For example, relative to typical maps, a map generated with GIS data provides the user with the ability to select the information needed to fit the needs of the goal the user is trying to achieve. For example, a business person trying to map customers in a particular city may desire to see very different information than a water engineer who desires to see the water pipelines for the same city. Both individuals may start with a common map—a street and neighborhood map of the city—but the information they retrieve from the GIS data included in the map will be very different. Similarly, a fireman preparing to enter a burning building may desire to see very different information about the building than would a landscape architect preparing to landscape the outer perimeter of the building.

To date, GIS databases have been designed and installed in a number of towns, cities, and municipalities. As a result, individuals such as engineers, planners, surveyors, and the like have enjoyed access to significant amounts of information relating to the surrounding land and improvements constructed thereon. However, the full capability of GIS has been fairly untapped by individuals other than such technical personnel (i.e., engineers, planners, surveyors, etcetera). Indeed, despite GIS databases being readily available in a number of communities via, for example, the internet, access to such GIS databases has generally not been taken advantage of by the public. This is due to a number of factors. For example, heretofore designed GIS maps of, for example, cities, towns, buildings, neighborhoods, are presented to the user in somewhat complex two-dimensional views. In particular, GIS maps have been presented to the user in the form of detailed plan views (i.e., overhead views) of the subject area. Such plan views are often very detailed and difficult for the general public to utilize.

### SUMMARY OF THE DISCLOSURE

According to one illustrative embodiment, there is provided a system for using GIS data in which a three-dimensional model of the architectural structure in question is presented to a user. When the user selects a portion of the three-dimensional model, GIS data associated with the selected portion is retrieved from a GIS database and displayed to the user. In a specific implementation, the three-dimensional model is displayed on a client machine of the user, and the GIS database is maintained on a server machine. As such, the GIS data desired by the user is retrieved across a network such as a global network (e.g., the internet).

In a more specific illustrative embodiment, there is provided a method of using GIS data. The method includes the steps of displaying a three-dimensional model of an architectural structure, determining a user-selected portion of the architectural structure, and retrieving GIS data associated with the user-selected portion of the architectural structure from a GIS database.

In another specific illustrative embodiment, there is provided a method of using GIS data. The method includes the steps of displaying a three-dimensional model of an architectural structure on a client machine, generating a user-request when a user operates an input device associated with the client machine so as to select a portion of the architectural structure, and downloading GIS data from a server machine to the client machine in response to generation of the user-request.

In yet another specific illustrative embodiment, there is provided a method of using GIS data that includes the steps of retrieving GIS data associated with an architectural structure from a GIS server machine via a network, and generating a three-dimensional model of the architectural structure which comprises the GIS data.

In another specific illustrative embodiment, there is provided a method of operating a network server. The method includes the steps of transferring image data associated with a three-dimensional model of an architectural structure to a client machine, retrieving GIS data associated with the architectural structure from a GIS database, and transferring the GIS data to the client machine.

In another specific illustrative embodiment, there is provided a method of providing GIS data associated with an architectural structure to a user. The method includes the steps of displaying on a client machine a three-dimensional model of the architectural structure to the user, and determining a user-selected portion of the architectural structure when the user operates an input device associated with the client machine. The method also includes the steps of retrieving via a global network GIS data from a GIS database in response to the determining step, and displaying to the user on the client machine the GIS data.

In regard to another specific illustrative embodiment, there is provided a network server. The network server includes a processor and a memory device electrically coupled to the processor. The memory device has stored therein a plurality of instructions which, when executed by the processor, cause the processor to transfer image data associated with a three-dimensional model of an architectural structure to a client machine, retrieve GIS data associated with the architectural structure from a GIS database, and transfer the GIS data to the client machine.

In another specific illustrative embodiment, there is provided an article which includes a computer-readable signal-bearing medium having therein a plurality of instructions which, when executed by a processor, cause the processor to communicate with a client machine so as to transfer image data associated with a three-dimensional model of an architectural structure thereto, retrieve GIS data associated with the architectural structure from a GIS database, and communicate with the client machine so as to transfer the GIS data thereto.

In another specific illustrative embodiment, there is provided a network server which includes a processor and a memory device electrically coupled to the processor. The memory device has stored therein a plurality of instructions which, when executed by the processor, cause the processor to generate a three-dimensional model of an architectural structure, determine a user-selected portion of the architectural structure, and retrieve GIS data associated with the user-selected portion of the architectural structure from a GIS database.

In regard to another specific illustrative embodiment, there is provided an article that includes a computer-readable signal-bearing medium having therein a plurality of instructions which, when executed by a processor, cause the processor to generate a three-dimensional model of an architectural structure, determine a user-selected portion of the architectural structure, and retrieve GIS data associated with the user-selected portion of the architectural structure from a GIS database.

The above and other features of the present disclosure will become apparent from the following description and the attached drawings.

### BRIEF DESCRIPTION OF THE DRAWINGS

FIG. 1 is a simplified block diagram of a network-based system which incorporates the features of the present disclosure therein;

FIG. 2 is a process flow diagram of the construction of a three-dimensional, photorealistic model of an architectural structure;

FIG. 3 is a process flow diagram of the construction of a client interface application;

FIG. 4 is a detailed block diagram of the network-based system of FIG. 1;

FIG. 5 is a detailed block diagram similar to FIG. 4, but showing optional tool modules; and

FIGS. 6-23 illustrate various screen displays which are displayed on a display monitor during operation of the system of FIG. 1.

### DETAILED DESCRIPTION OF AN ILLUSTRATIVE EMBODIMENT

While the concepts of the present disclosure are susceptible to various modifications and alternative forms, specific exemplary embodiments thereof have been shown by way of example in the drawings and will herein be described in detail. It should be understood, however, that there is no intent to limit the concepts of the present disclosure to the particular forms disclosed, but on the contrary, the intention is to cover all modifications, equivalents, and alternatives falling within the spirit and scope of the disclosure.

The present disclosure is directed to an apparatus, method, system, and program for providing GIS data to a user via an interface which includes a three-dimensional model of an architectural structure. As used herein, the term “architectural structure” is intended to mean any natural or manmade structure or structures which GIS data may be associated. For example, the term “architectural structure” may include, amongst other things, land plots or formations, lakes, rivers, roads, cities, towns, municipalities, neighborhoods, buildings, streets, sewers, light posts, billboards, etcetera.

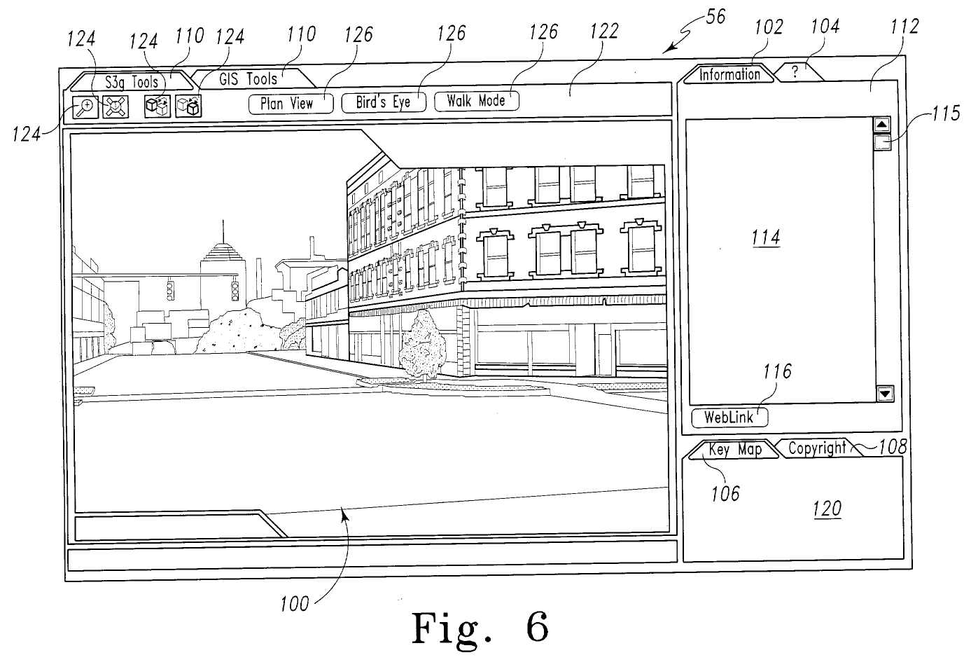

As shown in FIGS. 6-23, a photorealistic three-dimensional model of an architectural structure (in this case, a neighborhood in a city) is displayed to a user via a user interface such as a display monitor of a personal computer (PC). The user may navigate throughout the model to view the various features of the architectural structure. For instance, in the exemplary model shown in FIGS. 6-23, the user may navigate or “explore” the buildings, streets, or other structures associated with the neighborhood.

If the user desires certain information about any one or more portions of the three-dimensional model (e.g., one of the buildings in the neighborhood), the user may select the desired portion of the model by operating an input device such as the PC's mouse or keyboard. In response to this input-request, GIS data associated with the selected portion of the three-dimensional model is retrieved from a GIS database and displayed to the user. For example, if the user desires to know the date on which the building was built or the contractor who built the building, such information may be retrieved and displayed to the user. If the user desires to see a diagram of the buildings electrical system or water system, GIS data for generating a rendering of such systems is retrieved from the GIS database and then utilized to generate and display a three-dimensional rendering of such systems which are overlaid on the model.

In such a way, a user can retrieve GIS data while actually “feeling” like he or she is walking through a particular architectural structure. As such, the restrictions associated with a user's navigation of a plan view map are eliminated.

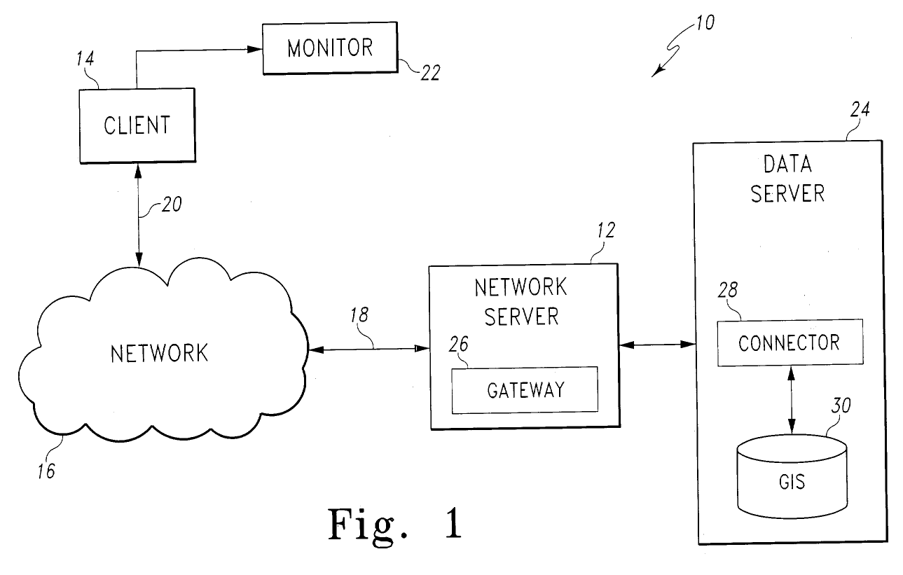

To do so, in regard to one illustrative embodiment, as shown in FIG. 1, a network-based system 10 has a network server machine 12 which communicates with a client machine 14 via a network 16. A data server 24 is coupled to the network server 12. Although only one network server 12, one client 14, and one data server 24 are shown in FIG. 1, it should be appreciated that the system may include any number of network servers 12, clients 14, or data servers 24.

In a conventional manner, each of the network servers 12, the clients 14, and the data servers 24 includes a number of components commonly associated with such machines. For example, although not shown in detail in the drawings, each of the network servers 12, the clients 14, and the data servers 24 may include, amongst other things customarily included in such machines, a central processing unit (“CPU”), a non-volatile memory such as a read only memory (“ROM”), a volatile memory such as a random access memory (“RAM”), and one or more data storage devices. It should also be appreciated that such components may be integrated into a single housing or may be provided as a number of separate, discrete devices. It should also be realized that the network server 12, the client 14, and the data server 24 may be operated with known, commercially available software operating systems.

As such, the network server 12 may be embodied as any type of commercially available network server. The storage devices associated with the network server 12 maintain a number of databases and files which are utilized in the construction and operation of an information portal such as a website. As will be described in greater detail below, the network server 12 also functions as a gateway 26 for exchanging information across networks that are incompatible and that use different protocols. The gateway 26 may be embodied as any combination of commercially available hardware and/or software that connects different types of networks such that information can be exchanged therebetween.

Similarly, the data server 24 may be embodied as any type of commercially available data server. The storage devices associated with the data server 24 maintain a number of databases and files which are utilized in the construction and operation of a GIS system. In particular, the data server 24 maintains one or more GIS databases 30 which include GIS data associated with a plurality of architectural structures. As will be described in greater detail below, the data server 24 also maintains a number of connector software components 28. The connectors 28 translate the format of data requests to and from the GIS databases.

The client 14 preferably includes an output device such as a display monitor 22 for displaying a number of images to a user. As such, the client 14 may be embodied as any type of commercially available computing device such as a personal computer (“PC”). Moreover, the client 14 may also be embodied as a “mobile” device such as a cellular phone, a mobile data terminal, a portable computer, a personal digital assistant (“PDA”), or some other device of similar kind.

As shown in FIG. 1, the network server 12 is coupled to the network 16 via a communications link 18, whereas the client 14 is coupled to the network 16 via a communications link 20. It should be appreciated that the communications links 18, 20 may be provided as any number of different types of data links including both wired and wireless data links. Moreover, it should also be appreciated that one or more intervening modems (not shown), data routers (not shown), and/or internet service providers (“ISPs”) (not shown) may be used to transfer the data between the network server 12, the client 14, and the network 16.

The network 16 of the present disclosure may be embodied as any type of network such as a LAN or WAN. Moreover, in a specific illustrative embodiment, the network 16 is embodied as a publicly-accessible global network such as the internet.

A user may utilize the client 14 to access information stored on the network server 12 (or on a device associated with the server 12). In the case of an internet-based system (i.e., the network 16 is embodied as the internet), the server 12 is embodied as a web server and, as such, hosts a website which may be accessed by the user from the client 14. In doing so, a number of image data files in the form of, for example, webpages including the three-dimensional model of the architectural structure may be downloaded from the server 12 to the client 14 via the network 16 for display to the user on the display monitor 22.

The user may then peruse the contents of the displayed model and select certain portions thereof in order to access GIS information associated with the architectural structure. In particular, the user may navigate through the three-dimensional model in order to determine information relating to the architectural structure embodied in the model. The user may select the portion or portions of the displayed model that the user desires information on by touching a particular key or “clicking” on the displayed image with an input device such as a mouse. The client 14 generates an output signal indicative of the user's selection and transmits the same to the network server 12 via the network 16.

The server 16 then analyzes the inputted data (i.e., the selected portion of the three-dimensional model) from the user and determines an appropriate response thereto. In particular, the server 12 may query a number of the GIS databases 30 or other data repositories in order to determine and retrieve GIS data associated with the user's request. Once the appropriate GIS data has been selected based on the request from the user, data files associated with GIS data are retrieved from the GIS databases 30 and transmitted to the client 14 via the network 16. The client 14 then utilizes the contents of such files to display to the user a number of images (both text and graphical) in the form of an updated three-dimensional model which includes the retrieved GIS data.

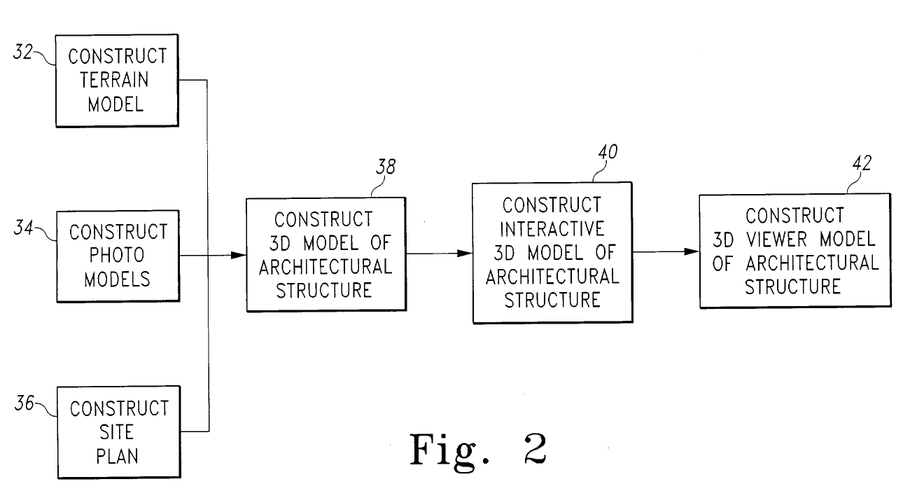

Referring now to FIGS. 2-5, there is shown a number of component flow diagrams which describe a specific exemplary process which utilizes specific exemplary software tools for creating and executing the aforedescribed process. The first phase in the process involves the creation of the photorealistic three-dimensional model of the architectural structure. To do so, a terrain model is constructed in process step 32 by use of a computer-aided design (hereinafter sometimes CAD) program, such as AutoCAD 2002 which is commercially available from Autodesk of San Rafael, Calif., as shown in FIG. 2. A terrain model depicts the topography and contours of the location being mapped. The terrain model may be constructed from aerial maps, survey reports, and previous topographic maps. A terrain model typically includes, amongst other things, land features such as hills, valleys, water beds, and the general undulations of the land.

Photo-models or “photometric models” of architectural structures of particular interest are constructed in process step 34 by use of a virtual reality modeling language (hereinafter sometimes VRML) program, such as PhotoModeler Professional 4.0 which is commercially available from Eos Systems, Inc. of Vancouver, British Columbia. A photo-model is generated of an architectural structure, for example a building structure, by taking photographs from different angles of the architectural structure so as to capture the different visible surfaces of the structure in the photographs. The photographs are trimmed and processed to be used as the visible surface or “skin” of the architectural structure in the final three-dimensional model. A photorealistic model is generated by applying these skins to the surfaces of the architectural structures. The photo-model process is typically performed for each architectural structure of particular interest such as buildings in the general location being mapped.

A site plan of the location being mapped is constructed in process step 36 by use of a CAD program, such as AutoCAD. A site model depicts the locations upon the map where the various architectural structures exist. A site model may be constructed from existing maps, survey reports, and proposal maps. A site model typically includes, amongst other things, such features as building footprints, roadway boundaries, and parking lot boundaries.

It should be appreciated that process steps 32, 34, and 36 may be completed in any order or be completed contemporaneously. In process step 38, the terrain model, the plurality of photo-models, and the site plan are imported into a three-dimensional modeling program, such as 3DS Max 5 which is commercially available from Discreet Products of Montreal, Quebec. The terrain model, photo-models, and site plan are then assembled together to create a completed three-dimensional model of the architectural structure, for example a neighborhood, of the location being mapped. Additional architectural structures, such as roadways, sidewalks, landscape features, and utility poles, may be constructed in the three-dimensional modeling program and combined into the three-dimensional model.

In process step 40, the three-dimensional model of the architectural structure created in step 38 is imported into a three-dimensional multimedia authoring program, such as Director 8.5 Shockwave Studio which is commercially available from Macromedia, Inc. of San Francisco, Calif. The use of a three-dimensional multimedia authoring program facilitates the creation of media-rich, dynamic, and interactive three-dimensional models. For example, motion of objects or structures can be introduced into the three-dimensional model by utilizing the authoring program. Additionally, the use of the three-dimensional multi-media authoring program allows for the dissemination of the three-dimensional model of the architectural structure over a network, for example the internet. In particular, in process step 40, the three-dimensional model may be compressed thereby reducing the transmission time of the model over the network to the user.

The construction of a photorealistic three dimensional model of the architectural structure is completed in process step 42 by converting the three-dimensional model into a format suitable for presentation to a viewer application. For example the three-dimensional model may be converted to a “.w3d” format which is viewable by a Shockwave plug-in which is commercially available from Macromedia, Inc. Generally, the viewer application is a plug-in application to a viewer environment, such as a web browser. For example, the viewer application may be embodied as a plug-in for use with Internet Explorer 6 which is commercially available from Microsoft of Redmond, Wash.

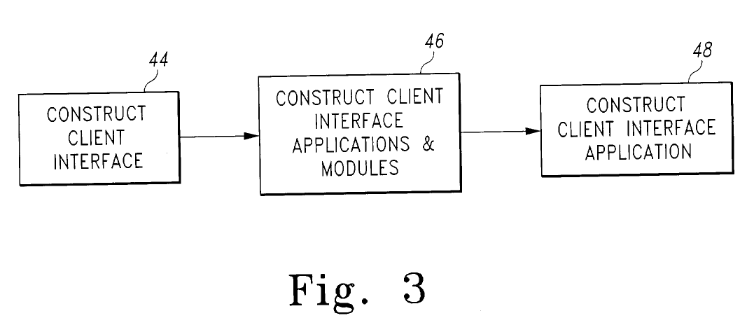

A client interface application is a user application for interfacing and interacting with a three-dimensional model. Generally, the client interface application is executed by a viewer application, such as Shockwave, being executed in a viewer environment, such as Internet Explorer 6. As shown in FIG. 3, the process flow for constructing a client interface application begins with the construction of a client interface in process step 44. The client interface constructed in process 44 is an interactive interface for viewing and interacting with the three-dimensional model of the architectural structure constructed in process steps 32-42 and is developed in a 3D multimedia authoring program, such as Director 8.5 Shockwave Studio. The use of a three-dimensional multimedia authoring program allows for the creation of the visual appearance of the client interface.

Additional applications and modules for incorporating and expanding the functionality of the client interface may be constructed in process step 46 by utilizing an object orientated programming language, such as Lingo which is commercially available from Macromedia, Inc. In process step 46, the functionality of the three-dimensional model of the architectural structure to be interfaced with an associated database or file, for example a GIS database, is developed. Additionally, applications for detecting when a user selects an architectural structure, such as a building, and transmitting associated data to the user can be constructed in process step 46. Toolset modules which provide additional functionality for different groups of users may also be constructed in process step 46. Toolset modules may include such functionality as the ability to hide particular layers or architectural structures, submit data queries relating to particular portions of the architectural structure or conditions, and acquire data of specific use to the user. For example, a toolset module designed for fire departments may include the functionality of computing and displaying to the user the number of gallons per minute required to extinguish a house fire existing in a selected house. Alternatively, a toolset module designed for public utility companies may include the functionality of displaying to the user the average power used in a selected home.

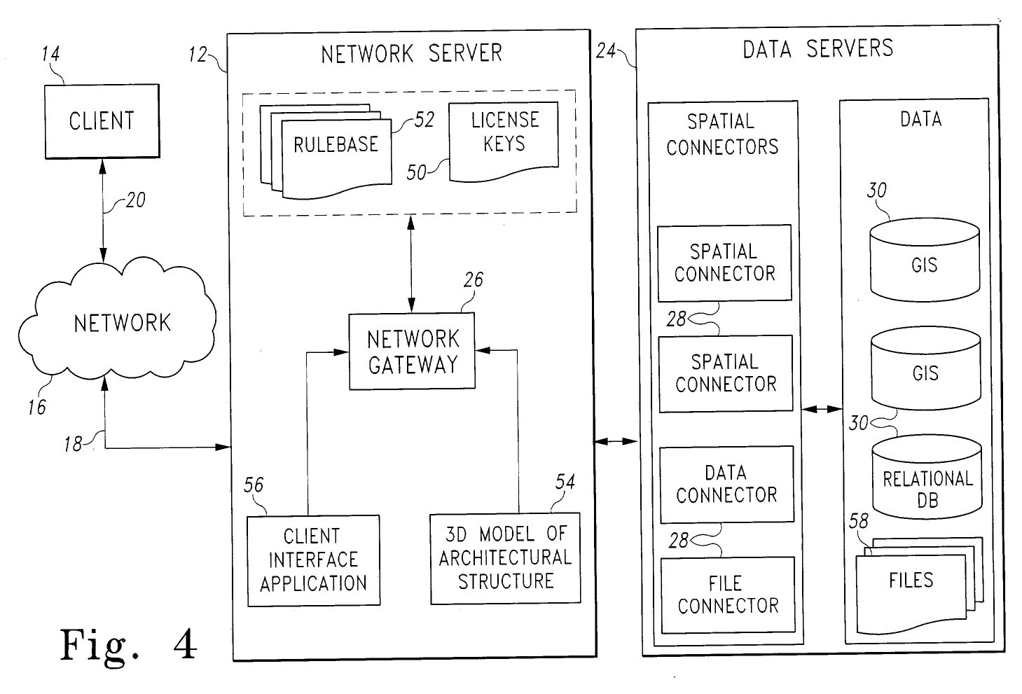

In process step 48, a client interface application for viewing and interacting with a three-dimensional model over a network is constructed. The client interface application is the completed, custom application which communicates with a viewer environment, such as Internet Explorer 6, employed by a user to present the three-dimensional model and facilitate interaction with the three-dimensional model and associated GIS data. The client interface application constructed in step 48 (and designated with reference number “56”) is stored on the network server 12, as shown in FIG. 4.

Referring now to FIG. 4, when a user via the client 14 accesses the network server 12 through the network 16, the server 12 checks one or more license keys 50 to ensure that the client 14 has the appropriate license. If the client 14 has the appropriate license, the license keys 50 and a rulebase 52 is transmitted to the client 14 through the network 16 across the communication links 18, 20 and stored on the client 14 thereby allowing later reference to the license keys 50 and the rulebase 52. The rulebase 52 contains a translation database which includes translations of identification labels of the architectural structure or portions thereof from those contained in the three-dimensional model to the identification labels of the architectural structure or portions thereof contained in databases, for example GIS databases. For example, a fire hydrant depicted in the three-dimensional model may include a name label of “FH” while the same fire hydrant in the associated GIS database may contain the name label “FHT”. The rulebase 52 would create a translation between these two identification labels, i.e. name labels, so that the data associated with the fire hydrant is accessible even though the fire hydrant is labeled differently in the three-dimensional model as compared to the GIS database.

Once the network server 12 has verified the license of the client 14 and transmitted the license keys 50 and the rulebase 52 to the client 14, a client interface application 56 is transmitted to the client 14. As described above, the client interface application 56 is the user application for interfacing and interacting with the three-dimensional model.

Once the client interface application 56 is transmitted to and executing on the client 14, additional data is transmitted to the client 14. In particular, the three-dimensional model of the architectural structure 54 is transmitted to the client 14. In some embodiments, the entire three-dimensional model is transmitted to the client 14. In other embodiments, portions of the three-dimensional model are transmitted over a time period beginning with those portions closest to the user's field of vision. Thereafter, the remaining portions of the three-dimensional model are transmitted to the client 14 in the background.

Once the three-dimensional model, or portions thereof, is/are transmitted to the client 14, the user can navigate through and interact with the three-dimensional model. In particular, if the user desires certain information about any one or more portions of the model, for example a building, the user may select the desired portion of the model. When a user selects a portion of a model, a request for GIS data associated with that portion is generated by the client interface application 56 and transmitted through the network 16 to the gateway 26. The gateway 26 forwards the request to one or more of the data servers 24. As shown in FIG. 4, a plurality of spatial connectors 28 may reside on each data server 24. The spatial connectors 28 function as request translators and translate the request received from the gateway 26 into a request suitable for presentation to the associated database 30 or file 58. In some embodiments, the databases 30 may be embodied in a proprietary format that requires uniquely formatted requests. In this case, the associated connector 28 would translate the generic request into a properly formatted request suitable for presentation to the proprietary formatted database. As such, depending on the type of request received, an appropriate spatial connector 28 is selected and the requested data is extracted from the associated database 30 or file 58. Once the data is extracted from the associated database 30 or file 58, the spatial connector 28 formats the extracted data for presentation back to the client 14 through the client interface application 56. For example, GIS data associated with a particular fire hydrant may be embodied in a GIS database which utilizes a proprietary format. A request for information associated with the fire hydrant must be translated into a request having the proper format to access the GIS database 30. Once the information is extracted from the GIS database 30, the spatial connector 28 will reformat the data for presentation to the client 14 through the client interface application 56.

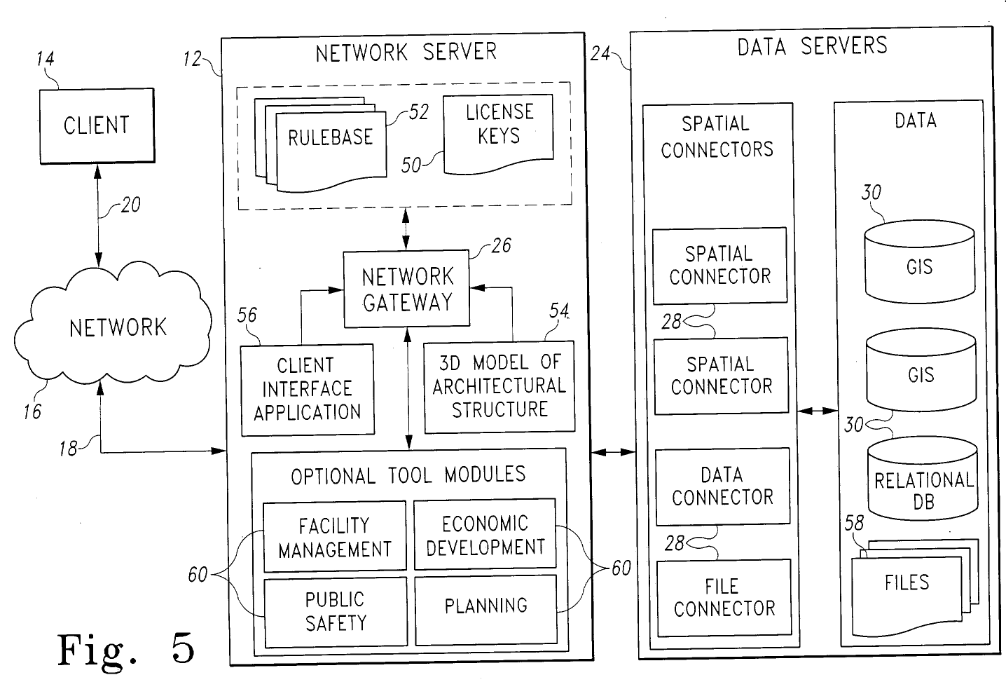

Once the requested data is extracted from the appropriate database 30 in FIG. 5, the data is transmitted back to the network gateway 26. The gateway 26 forwards the data to the client 14 through the network 16. When the client 14 receives the requested data, the data is displayed in the appropriate location on the client interface application 56 being executed on the client 14. The user can continue to navigate around the three-dimensional model and continue requesting data associated with portions of the model.

The user may also input data associated with a portion of the model, such as a building, into one of the databases 30 or the files 58. To do so, the user may select a portion of the model, as described above in relation to obtaining data for the selected portion of the model, and then select or “click” on the appropriate data tool button (see, e.g. FIGS. 6-23). Once the data tool button is selected, the user is prompted to enter data to be associated with the portion of the model selected by utilizing the client interface application 56. Once the data is entered, it is transferred to the network server 12 via the network 16. The network server 12 transmits the data to the data server 24. The spatial connectors 28 residing on the data server 24 translate the data into the proper format for storage and stores the data in the appropriate database 30 or file 58.

As shown in FIG. 5, additional optional tool modules 60 may be employed by the client interface application 56 to provide additional functionality to the user. As shown in FIG. 5, the tool modules 60 reside on the network server 12. Generally, tool modules 60 are collections of additional tools and functionality specifically designed for a specific group of users. For example, optional tool modules 60 may include a facility management module, a public safety module, an economic development module, and a planning module. The individual tools and functionality contained in a module vary according to the module. Some examples of additional tools and functionality may be the ability to hide or display specific portions of the architectural structure, the ability to view specific data related to a portion of the architectural structure, or enhanced movement capabilities.

The tool modules 60 available to a user may be determined by the user group within which the user is a member. The tool modules 60 available to a specific user is contained in the license keys 50 which is initially stored on the network server 12. As such, once the availability of a specific number of the tool modules 60 to a particular user is determined, the appropriate modules 60 are transmitted to the client 14 from the network 12. The client interface application 56 executing on the client 14 receives the modules 60 and updates the visual appearance of the interface application 56 to provide access to the tool modules 60. For instance, a tool module 60 designed for “public safety” may be accessible by the local police and fire department. The “public safety” tool module 60 may provide the fire department with the functionality to display special icons depicting the nearest fire hydrants to a selected location. Additionally, the “public safety” tool module 60 may provide the police department with the functionality to plot the shortest path between to selected locations and display this path on the client interface application 56. Similarly, a tool module 60 designed for “facility management” may be accessible by the local utility companies. The “facility management” tool module 60 may provide the public utility company with the functionality to display the average power consumption of selected buildings, thereby allowing the public utility company to analyze their power production requirements.

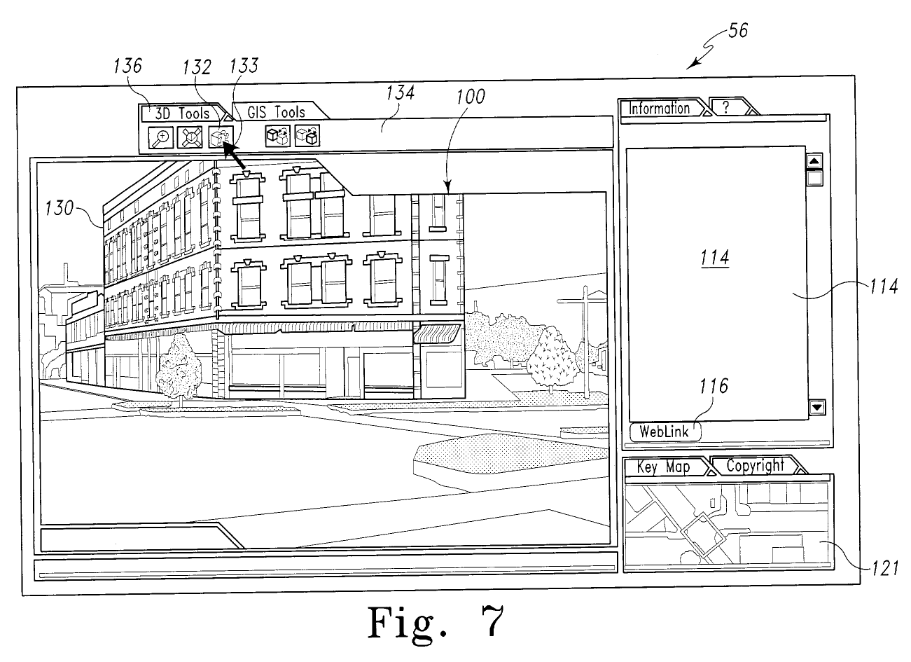

An illustrative client interface application 56 is shown in FIG. 6 and includes a model view window 100, an information tab 102, a help tab 104, a key map tab 106, a copyright tab 108, and a plurality of tool tabs 110. Each tab 102, 104, 106, 108, and 110 has an associated panel. For example, by selecting or clicking on the information tab 102, an information panel 112 is displayed towards the right side of the interface application 56. The information panel 112 includes an information display 114, a scroll bar 115, and a WebLink button 116. By selecting or “clicking” on the help tab 104, a help panel (not shown) is displayed and contains a help display (not shown) which provides a searchable help index or the like to the user. In a similar fashion, the key map tab can be selected or “clicked” on to display a key map panel 120 in the lower right corner of the client interface application 56. Key map panel 120 includes a key map display 121 (see, e.g., FIG. 7). Selecting the copyright tab 108 displays a copyright panel (not shown) including a copyright display (not shown) which provides relevant copyright information to the user. Additionally, the tool tabs 110 can be selected to display associated tool bars 122 in the upper portion of the interface application 56. Each tool bar 122 has a plurality of associated tool buttons 124.

The three-dimensional model of the architectural structure 54 is displayed to the user in the model view window 100. The user can navigate through and around the model 54 utilizing various methods, such as pressing the “arrow” keys on a keyboard of the client machine 14. As the user maneuvers around the model 54, the portions of model 54 that are visible to the user are rendered in real time. Additionally, an overhead view of the location of the user is displayed on the key map display 121 (see, e.g., FIG. 7). Displaying the location of the user in an overhead view on the key map display allows the user to more easily navigate the model 54.

When a user desires information related to a specific portion of the model 54, for example a building, the user only needs to select that portion. Once a portion is selected by the user, data associated with the selected portion is retrieved from the associated databases 30 or files 58 and transmitted to the client 14 for use by the client interface application 56, as described above in regard to FIG. 3. Data, such as GIS data, associated with a selected portion is displayed in the information display 114 of the interface application 56. If the amount of associated data is too large to be displayed completely in the information display 114, scroll bar 115 can be used to scroll up or down to view the entirety of the data. Additionally, by clicking the WebLink button 116, the user can be connected to a website associated with the selected portion by utilizing a viewer environment, such as Internet Explorer 6. For example, if the selected portion is a restaurant building, clicking the associated WebLink button 116 may connect the user to the website of the restaurant.

The user may select one of the tool tabs 110 to display an associated tool bar 122. Each associated tool bar 122 contains a plurality of tool buttons 124 which can be selected to provide additional functionality. Similar tool buttons 124 are collected together on a common tool bar 122. Additionally, tools associated with an optional tool module 60 will include specific tool buttons 124 on a tool bar 122 identified by a tool tab 110 associated with the module 60. For example, a single tool bar 122 may contain movement functionality tool buttons 126. The movement functionality tool buttons 126 may contain a plan view tool button, a bird's eye tool button, and a walk tool button. Selecting one of these movement functionality tool buttons 126 may provide different modes of travel around the model 54.

If a user is uncertain how to properly use the client interface application 56 or requires additional information concerning the functionality of application 56, the user can select the help tab 104 to display the help panel (not shown). The help panel will be displayed over and hides the information panel 112. Help information is displayed in the help panel. Additionally, the user can acquire information concerning the copyright of the client interface application 56 by selecting the copyright tab 108. Selecting the copyright tab 108 displays the copyright panel (not shown). The copyright panel is displayed over and hides the key map panel 120. Copyright information can then be viewed in the copyright panel.

Referring now to FIGS. 7-23, there is shown a number of additional screen displays which demonstrate the aforedescribed concepts in the context of a specific exemplary embodiment. As shown in FIG. 7, a section of a three-dimensional model of the architectural structure 54, illustratively a neighborhood, corresponding to the user's view is downloaded by the client 14 from the network server 12 and displayed on the monitor 22 in the model view window 100 of the client interface application 56. The view of the model 54 displayed in window 100 may include several portions of the model including several different structures. For example, in FIG. 7, a building 130 is displayed in the center of window 100. An overhead view of the surrounding area relative to the user is displayed in the key map display 121. The key map display 121 is updated as the user moves about the model 54.

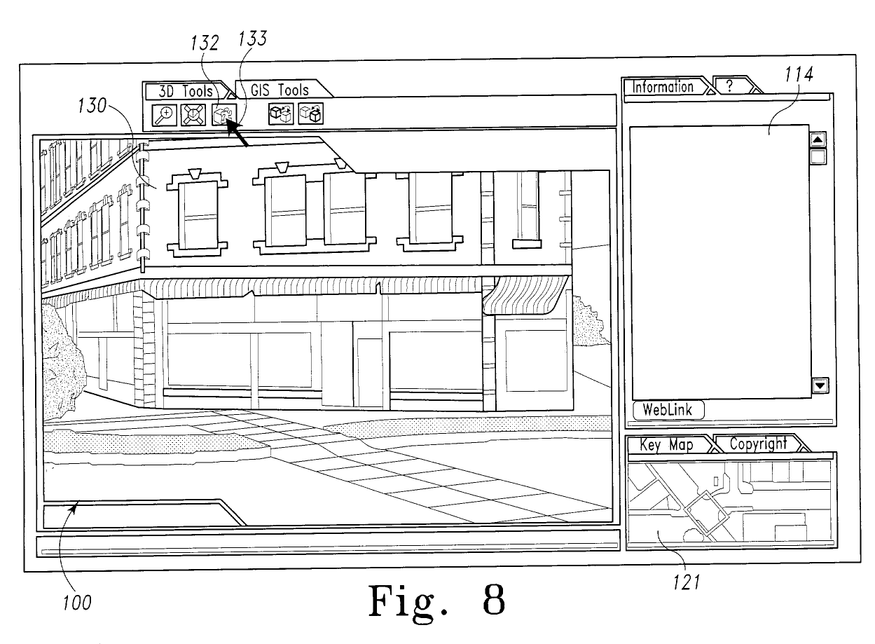

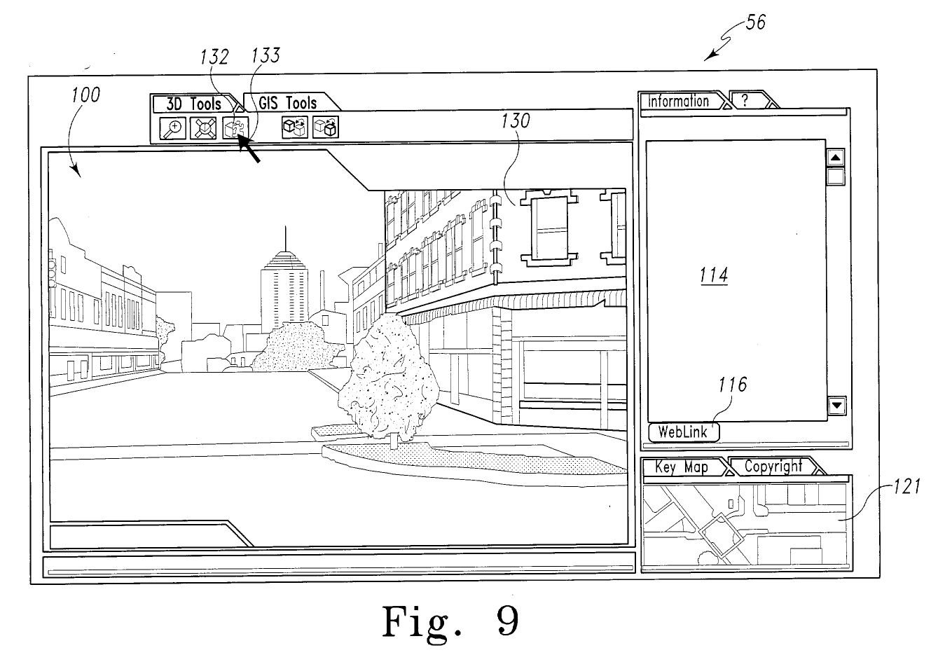

The user can move or navigate through the model 54 utilizing various methods, such as pressing the “arrow” keys on a keyboard of the client 14. To begin navigating the model 54, the user may “click” a movement button 132 with cursor 133 or otherwise select the movement button 132 as shown in FIG. 7. Illustratively, movement button 132 is included in a toolbar 134 associated with a 3D Tools tab 136. “Clicking” or otherwise selecting tab 136 will display toolbar 134 and thereby provide access to movement button 132. As can be appreciated by comparing FIGS. 7-9, a user can navigate throughout the model 54 and perform such activities as viewing building 130 more closely as shown in FIG. 8 or view an alternative angle and side of building 130 as shown in FIG. 9. In essence, the user can “walk” through the model 54 in a similar manner as one would walk through the neighborhood portrayed in the model 54. As such, the three-dimensional model 54 may be constructed with readily available collision detection techniques to prevent, for example, the user from “walking” through a wall or the like.

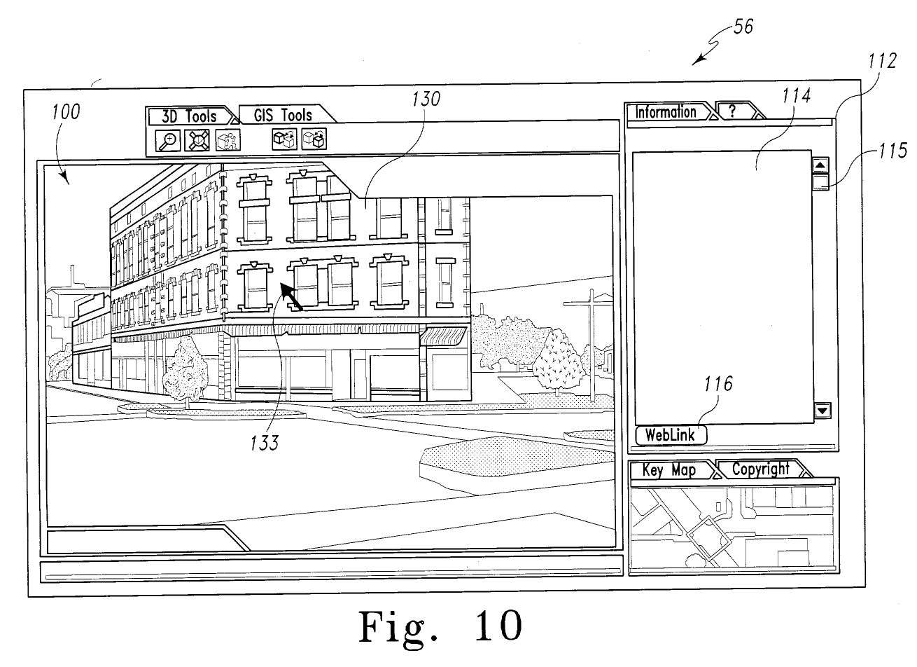

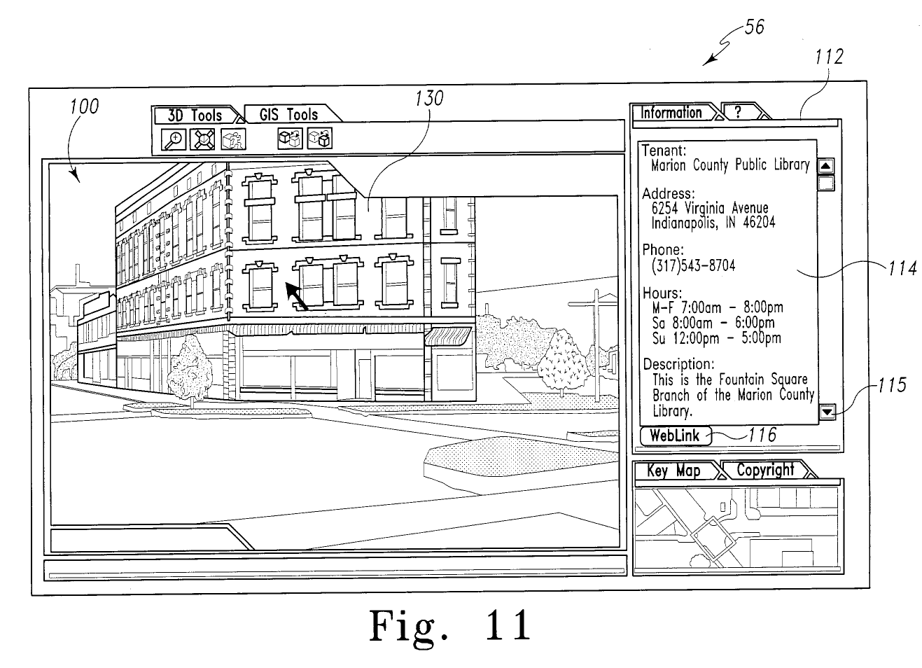

Throughout the navigation of the model 54, the user may desire information, such as GIS data, associated with portions of the model 54. As shown in FIG. 10, a user may “click” on or otherwise select the portion of the model 54, for example building 130, for which the user desires additional information. Data, for example GIS data, associated with the selected portion of the model 54 is retrieved from the data servers 24 by the network server 12, transmitted to the client 14, and displayed in the information display 114 of the information panel 112 of the client interface application 56. For example, as shown in FIG. 11, GIS data associated with the selected building 130 is displayed in the display 114 of the application 56. Illustratively, the data associated with the building 130 and displayed in the display 114 includes the name of the tenant of the building 130, the street address of the building 130, the phone number of the tenant of the building 130, hours of operation of the building 130, and a brief description of the building 130 and its tenant. Additional data associated with the building 130 may be viewed by utilizing the scroll bar 115 to scroll the information display 114. Additionally, a website associated with the building 130 may be viewed by “clicking” or otherwise selecting the WebLink button 116.

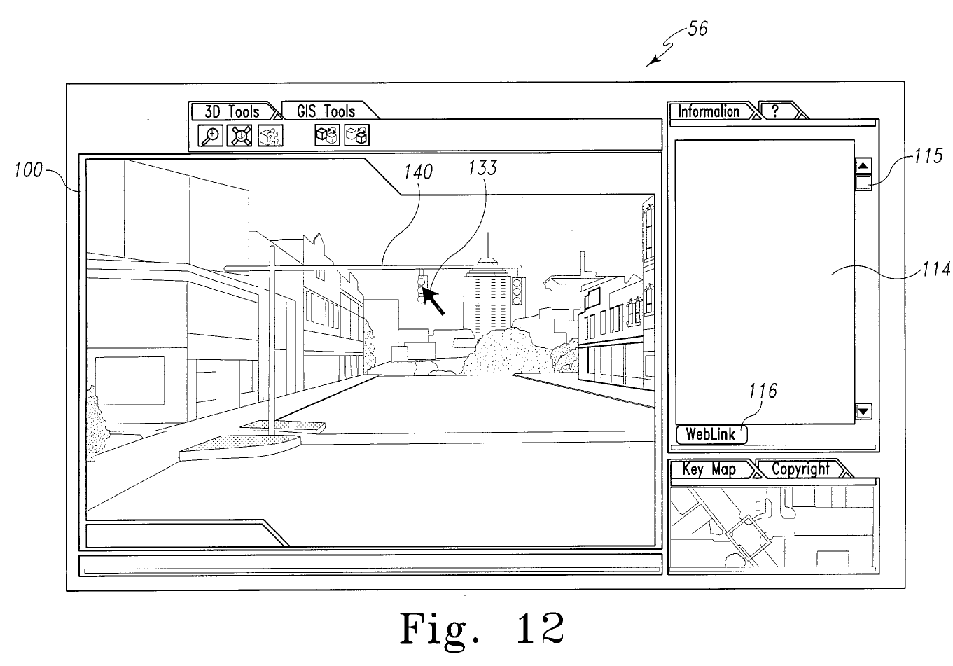

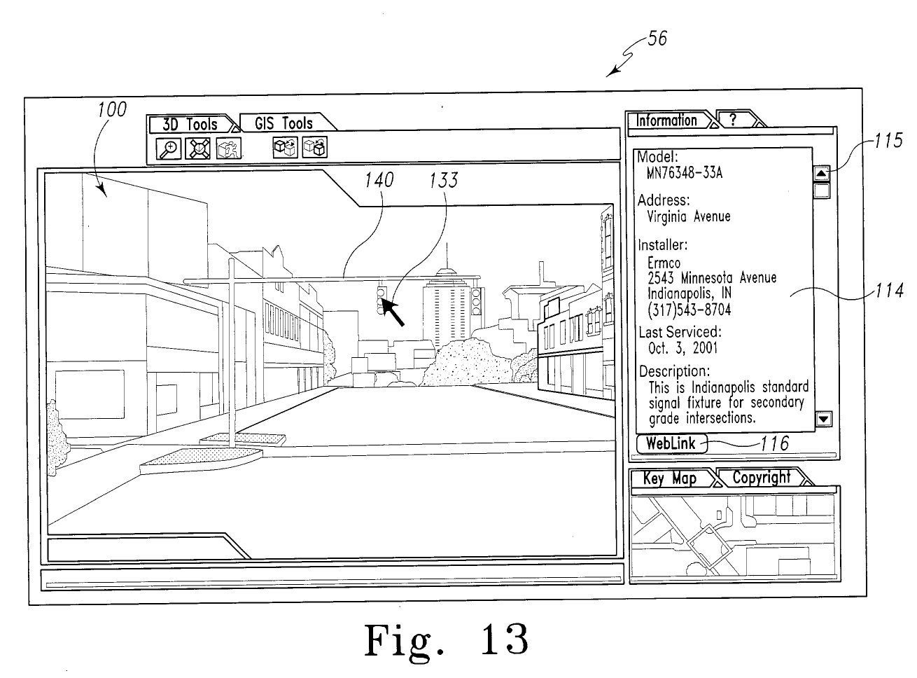

Data associated with other portions of model 54 (e.g., other architectural structures) may be retrieved in a similar manner as described above in relation to the building 130. For example, as shown in FIG. 12, an intersection signal assembly 140 may be selected by the user. Similar to selecting the building 130, selecting the signal assembly 140 causes data, for example GIS data, associated with the signal assembly 140 to be retrieved from the data servers 24 by the network server 12 and transmitted to the client 14. The data associated with the signal assembly 140 is displayed on the client interface application 56 in the information display 114 as shown in FIG. 13. Illustratively, the data associated with the signal assembly 140 and displayed in the display 114 includes the model number of the signal assembly 140, the address or general location of the signal assembly 140, information pertaining to the contractor or installer of the signal assembly 140, the date of the last service performed on the signal assembly 140, and a brief description of the signal assembly 140. Additional data associated with the signal assembly 140 may be viewed by utilizing the scroll bar 115 to scroll the display 114. Additionally, a website associated with the signal assembly 140 or alternatively associated with the installer of the signal assembly 140 may be viewed by selecting the WebLink button 116.

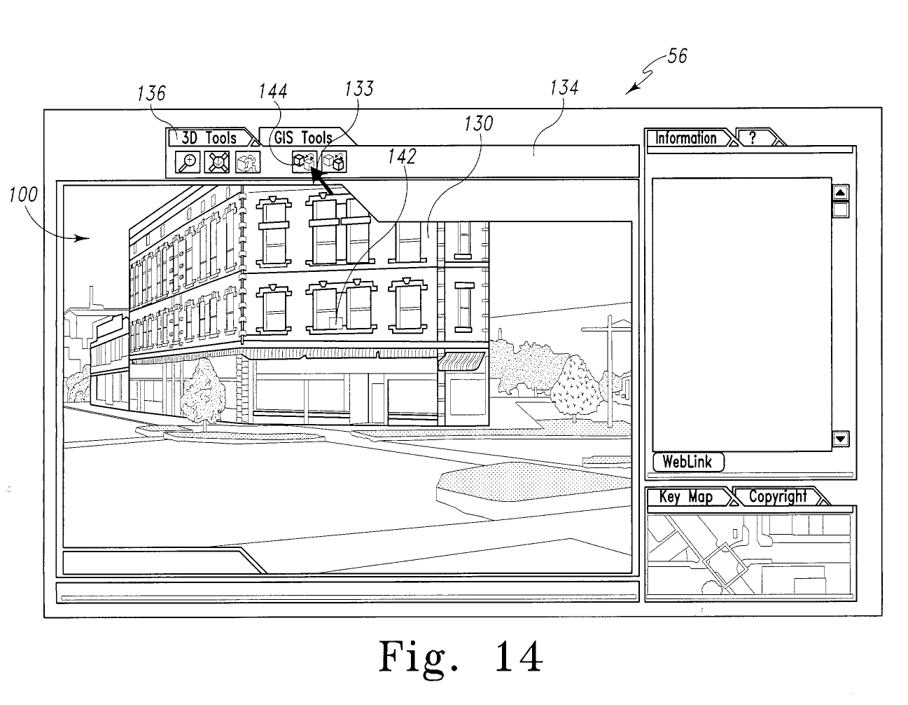

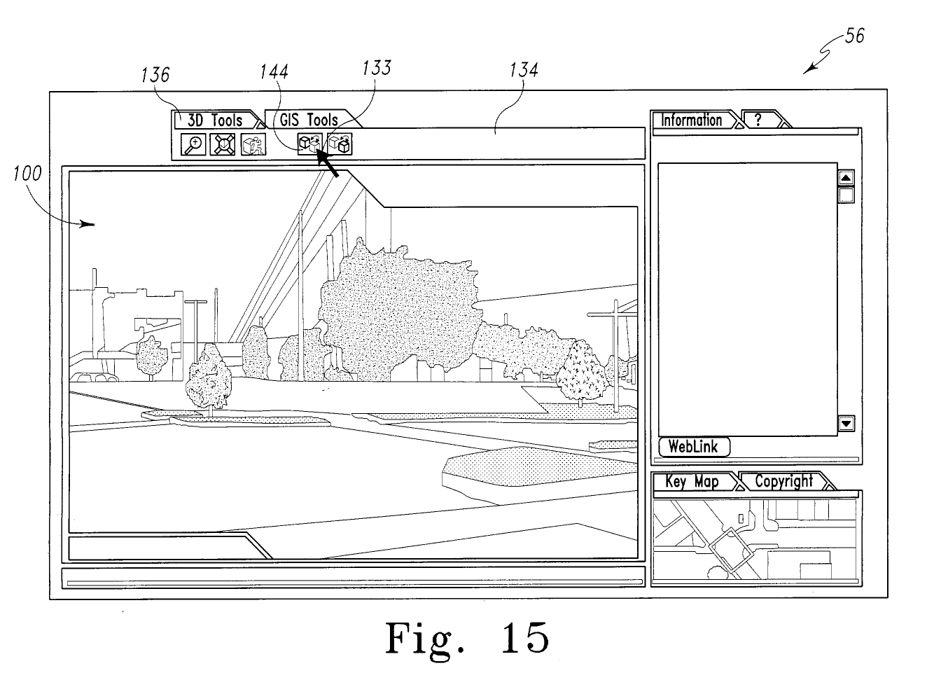

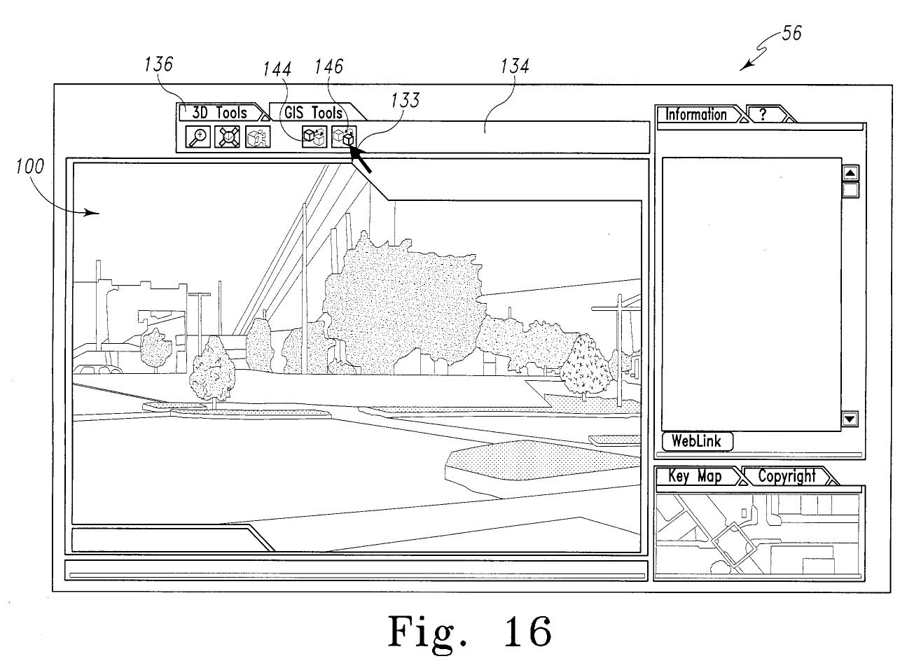

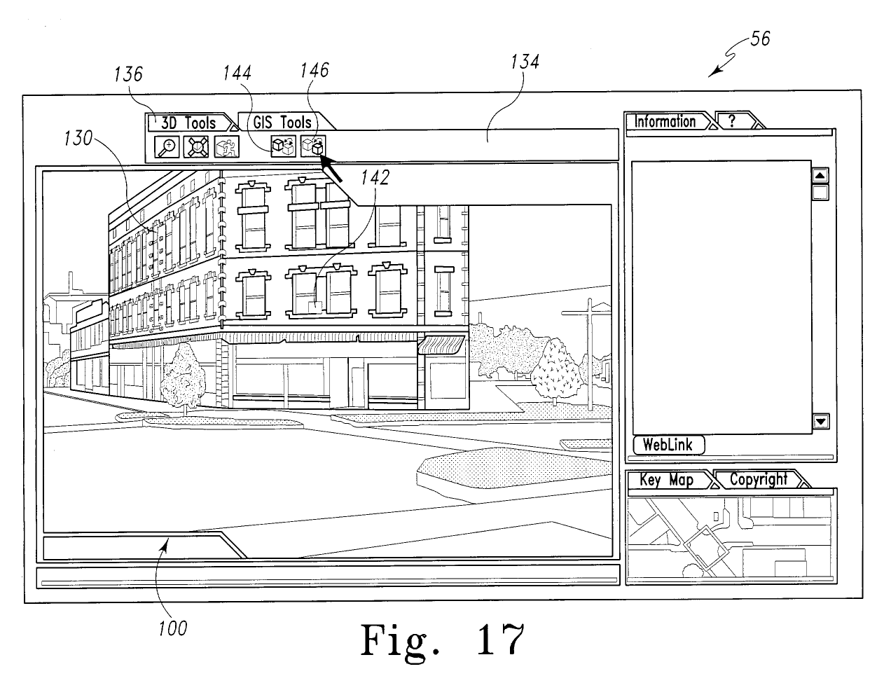

The user may also alter the view of the section of the three-dimensional model of the architectural structure 54 by hiding portions of the model 54. Hiding portions, for example buildings, of model 54 allows a user to see additional sections of model 54 which may otherwise be obstructed. Additionally, “before and after” views of proposed renovations or additions can be shown by utilizing the hide and show functionality of the client interface application 56. For example, the building 130 of the three-dimensional model 54 can be hidden and unhidden as shown illustratively in FIGS. 14-17. In FIG. 14, the building 130 of the model 54 is selected by “clicking” on or otherwise selecting an area of the building 130. An indicator box 142 appears centrally located on the selected building 130 to indicate that the building 130 has been selected. Once the user has selected the portion of the model 54 to be hidden, for example building 130, the user may “click” on or otherwise select a hide button 144 which is illustratively located on the toolbar 134 associated with a 3D Tools tab 136. Selecting the hide button 144 will cause the selected portion of the model 54, i.e. the building 130, to be hidden from the user's view, as shown in FIG. 15. Sections of the model 54 that were obstructed from the user's view by the selected portion of the model 54 are now viewable with the selected portion of the model 54 hidden. The portion of model 54 which was hidden from view can be “unhidden” by “clicking” on or otherwise selecting a show button 146 which is illustratively located on the toolbar 134 associated with the 3D Tools tab 136, as shown in FIG. 16. Selecting the show button 146 will cause the selected portion of model 54 which was previously hidden, i.e. the building 130, to reappear in the model view window 100 in the original location of the portion of model 54, as shown in FIG. 17. The functionality of being able to hide portions of the model 54 allows the user to customize the view depicted in the model view window 100 and view sections of the model 54 previously obstructed by the hidden portion.

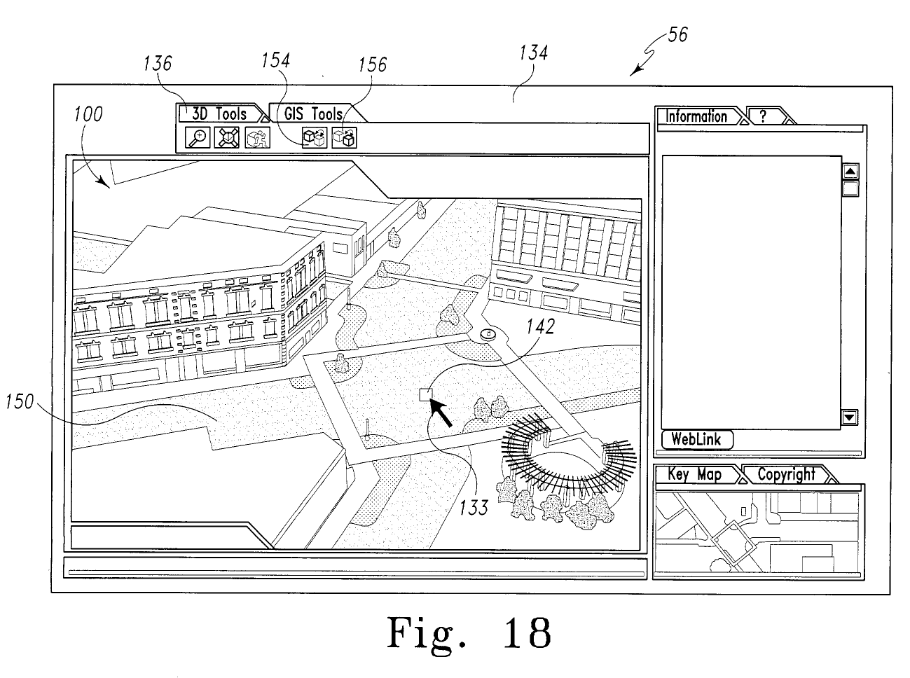

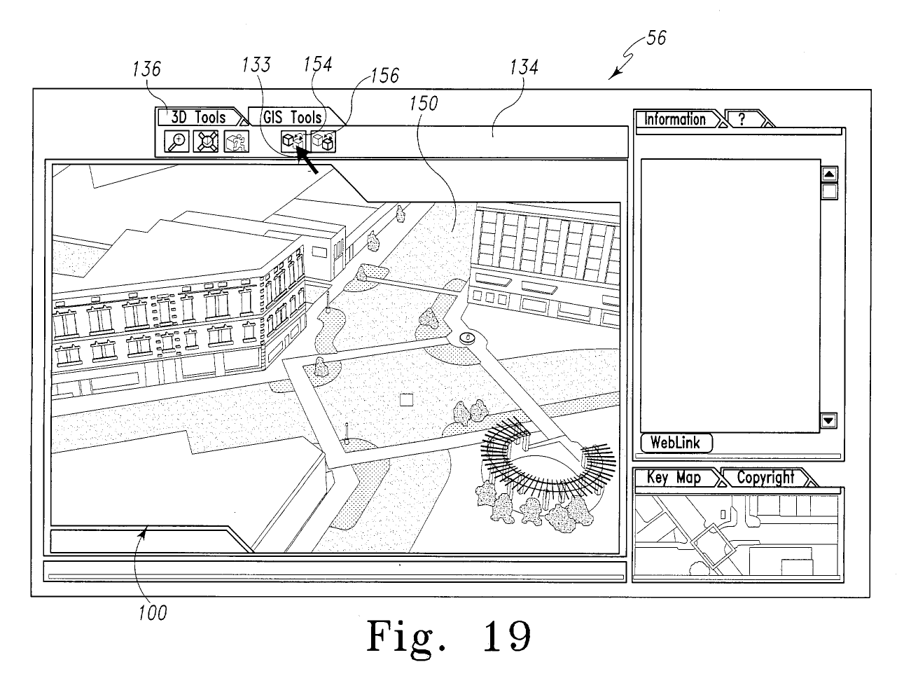

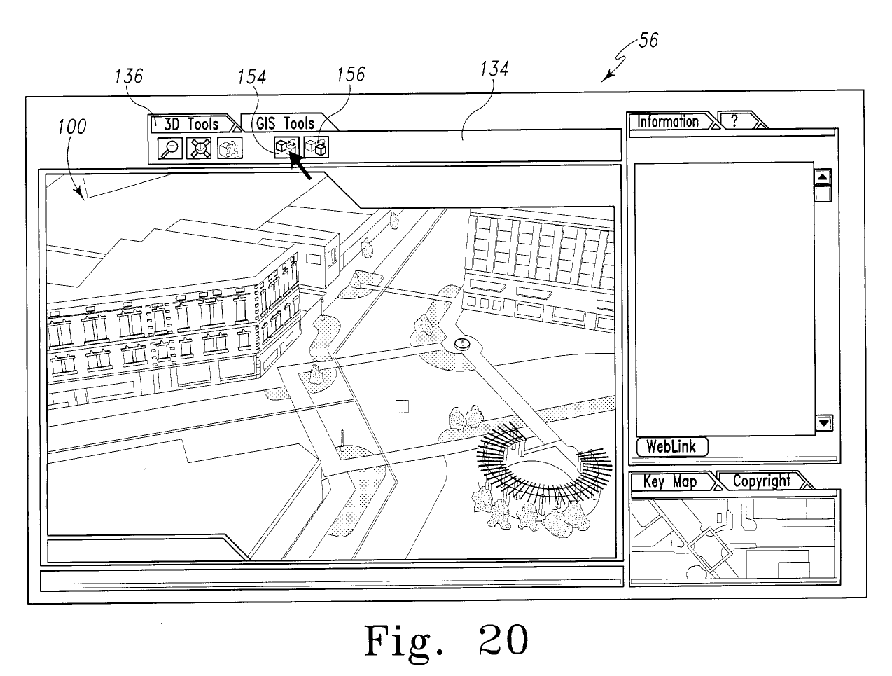

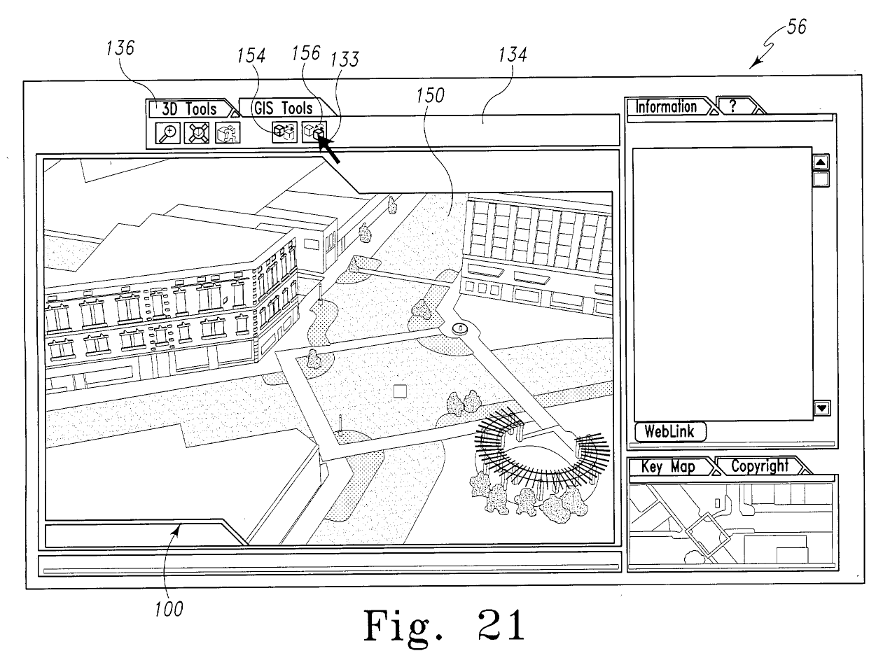

In addition to hiding portions of the three-dimensional model 54, a user may hide an entire layer of the model 54. The functionality of being able to hide layers of the three-dimensional model 54 allows the user to view those portions or layers of the model 54 of interest to the user and hide the entirety of portions not of interest to the user. Generally, hiding a layer of the model 54 will cause every portion of model 54 associated with that layer to be hidden. For example, a user may hide all the streets 150 of the model 54 by hiding the layer containing the streets 150 of the model 54, as shown illustratively in FIGS. 18-21. A user first selects a portion of the model 54 which is included in the layer to be hidden. For example, in FIG. 18, a street 150 of the model 54 is selected by “clicking” on or otherwise selecting an area or portion of the street 150. An indicator box 142 appears on the selected street 150 to indicate that the street 150 has been selected. Once the user has selected a portion of the model 54, for example the street 150, included on the layer to be hidden, the user may “click” on or otherwise select a hide layer button 154 which is illustratively located on the toolbar 134 associated with the 3D Tools tab 136, as shown in FIG. 19. Selecting the hide layer button 154 will cause the layer which includes the selected portion of the model 54, i.e. the layer containing all the streets of the model 54, to be hidden from the user's view, as shown in FIG. 20. The layer of model 54 which was hidden from view can be “unhidden” or shown by “clicking” on or otherwise selecting a show layer button 156 which is illustratively located on the toolbar 134 associated with the 3D Tools tab 135, as shown in FIG. 21. Selecting the show layer button 156 will cause the selected layer of the model 54 which was previously hidden, i.e. the layer containing the streets of the model 54, to reappear in the model view window 100, as shown in FIG. 21. The functionality of being able to hide layers of the model 54 allows a user to concentrate on those portions of the model 54 which are of interest to the user or the user's group.

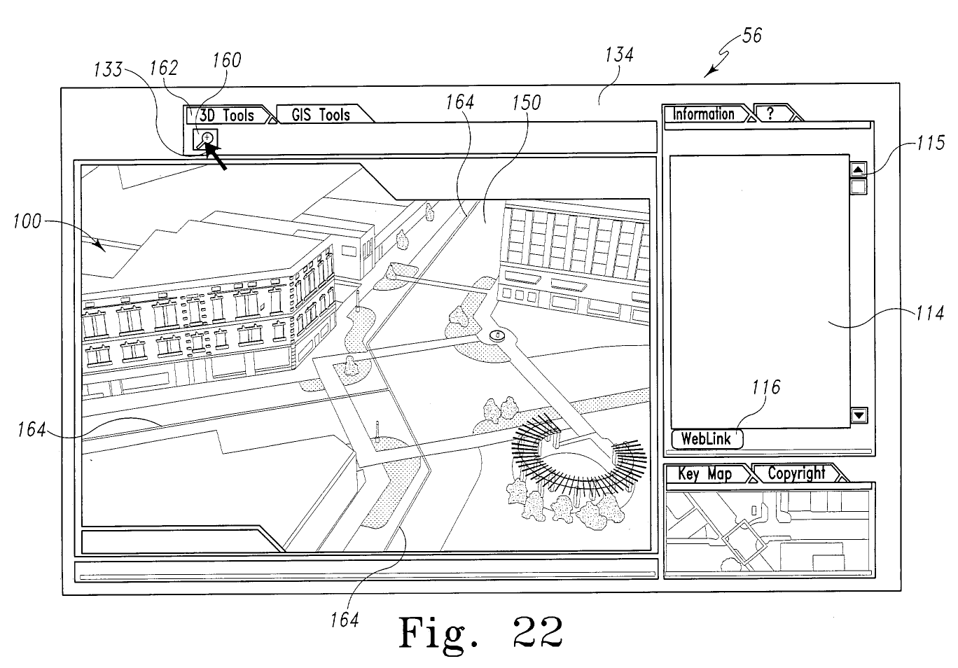

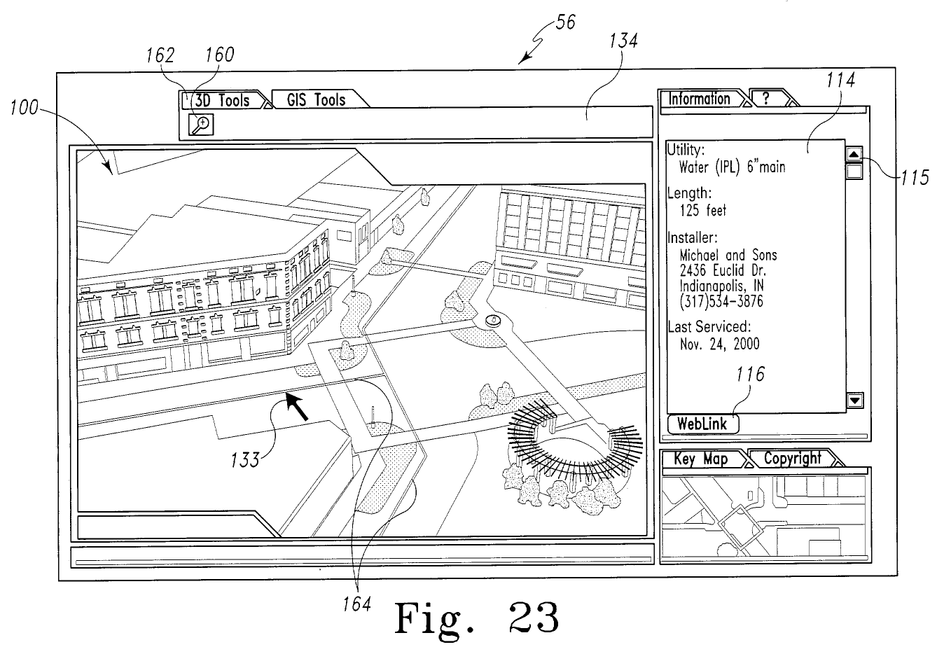

Additional functionality of the client interface application 56 may be available to different user groups, for example a public utility user group. In particular, additional functionality may be provided by an optional tool module 60 (see, e.g., FIG. 5) which is available to the user group of which the user is a member. For example, a tool module 60 provided to a public utility user group may provide the ability to view waterlines present under the streets 150 of the model 54. As shown in FIGS. 22-23, a member of the public utility user group may view the water lines and the data associated with the water lines. To do so, the user may “click” on or otherwise select a show waterlines button 160 which is illustratively located on the toolbar 134 associated with a GIS Tools tab 162, as shown in FIG. 22. Selecting the show waterlines button 160 will cause the waterlines 164 present under the streets 150 of the model 54 to appear in an overlay view over the street 150, as illustratively shown in FIG. 22. For easier viewing, the user may hide the layer of the model 54 which contains the streets of the model 54 as mentioned above. Once the waterlines 164 are displayed, a user may “click” on or otherwise select a portion of the waterlines 164 to display data, such as GIS data, associated with the water lines 164, as shown in FIG. 23. When the user selects a portion of the waterlines 164, GIS data associated with the waterlines 164 is retrieved from the data servers 24 by the network server 12 and transmitted to the client 14. The GIS data associated with the waterlines 164 is displayed on the client interface application 56 in the information display 114 as shown in FIG. 23. Illustratively, the GIS data associated with the waterlines 164 and displayed in display 114 includes the type and name of the utility, the length of the waterline, the name of the contractor or installer of the waterline, and the date of the last serviced performed on the waterline. Additional GIS data associated with the waterlines 164 may be viewed by utilizing the scroll bar 115 to scroll the display 114. Additionally, a website associated with the waterline 164 or alternatively associated with the installer of waterline 164 may be viewed by selecting the WebLink button 116. Additional utility lines and associated GIS data can be viewed in a similar manner. Additional functionality may also be included in other user' groups and/or in other optional tool modules 60.

It should be appreciated that the images of the waterline 164 shown in FIGS. 22-23 may be generated by use of the retrieved GIS data. In particular, when the user indicates that he or she desires to see the waterlines 164, GIS data in the form of coordinate data is retrieved from the GIS databases 30. The client interface application 56 uses such coordinate data to generate the layer containing waterlines 164. Once generated, the layer containing the waterlines 164 is then overlaid onto the model. It should be appreciated that numerous other types of layers may be constructed in a similar manner. By generating the images of the layer from coordinate data, file transmission times is reduced. In particular, since only numerical data need be transmitted (as opposed to image data), such data can be transmitted relatively quickly.

As described herein, the concepts of the present disclosure have numerous advantages relative to heretofore designed systems. For example, a user can retrieve GIS data while actually “feeling” like he or she is walking through a particular architectural structure. As such, the restrictions associated with a user's navigation of a plan view map are eliminated. Presenting GIS data through a three-dimensional model provides access to GIS and other data to users who are not familiar with GIS systems. The ease of navigation and data retrieval associated with a three-dimensional model GIS system reduces the technical knowledge required by the user and therefore provides access to a greater number of people.

While the disclosure has been illustrated and described in detail in the drawings and foregoing description, such an illustration and description is to be considered as exemplary and not restrictive in character, it being understood that only illustrative embodiments have been shown and described and that all changes and modifications that come within the spirit of the disclosure are desired to be protected.

There are a plurality of advantages of the present disclosure arising from the various features of the apparatus, methods, systems, and programs described herein. It will be noted that alternative embodiments of each of the apparatus, methods, systems, and programs of the present disclosure may not include all of the features described yet still benefit from at least some of the advantages of such features. Those of ordinary skill in the art may readily devise their own implementations of apparatus, methods, systems, and programs that incorporate one or more of the features of the present invention and fall within the spirit and scope of the present disclosure as defined by the appended claims.

For example, although the software concepts disclosed herein are described as already being loaded or otherwise maintained on a computing device (e.g., either a client or server machine), it should be appreciated that the present disclosure is intended to cover the software concepts described herein irrespective of the manner in which such software concepts are disseminated. For instance, the software concepts of the present disclosure, in practice, could be disseminated via any one or more types of a recordable data storage medium such as a modulated carrier signal, a magnetic data storage medium, an optical data storage medium, a biological data storage medium, an atomic data storage medium, and/or any other suitable storage medium.

1. A method of using GIS data, the method comprising the steps of:
displaying a three-dimensional model of an architectural structure,
determining a user-selected portion of the architectural structure, and
retrieving GIS data associated with the user-selected portion of the architectural structure from a GIS database.

2. The method of claim 1, wherein:
the displaying step comprises displaying the three-dimensional model of the architectural structure on a client machine, and
the retrieving step comprises retrieving the GIS data from the GIS database maintained on a server machine.

3. The method of claim 2, wherein the retrieving step further comprises retrieving the GIS data via a network.

4. The method of claim 2, wherein the retrieving step further comprises retrieving the GIS data via a publicly-accessible global network.

5. The method of claim 1, further comprising the step of displaying an updated three-dimensional model of the architectural structure that includes a substructure generated with the retrieved GIS data.

6. The method of claim 1, wherein the displaying step comprises displaying a photorealistic three-dimensional model of the architectural structure.

7. A method of using GIS data, the method comprising the steps of:
displaying a three-dimensional model of an architectural structure on a client machine,
generating a user-request when a user operates an input device associated with the client machine so as to select a portion of the architectural structure, and
downloading GIS data from a server machine to the client machine in response to generation of the user-request.

8. The method of claim 7, wherein the downloading step comprises downloading GIS data from the server machine to the client machine via a publicly-accessible global network.

9. The method of claim 7, wherein the generating step comprises transmitting the user-request from the client machine to the server machine via a publicly-accessible global network.

10. The method of claim 7, further comprising the step of displaying an updated three-dimensional model of the architectural structure that comprises the downloaded GIS data.

11. The method of claim 7, wherein the displaying step comprises displaying a photorealistic three-dimensional model of the architectural structure on the client machine.

12. A method of using GIS data, the method comprising the steps of:
retrieving GIS data associated with an architectural structure from a GIS server machine via a network, and
generating a three-dimensional model of the architectural structure which comprises the GIS data.

13. The method of claim 12, wherein the generating step comprises generating the three-dimensional model on a network server machine.

14. The method of claim 12, further comprising the step of displaying the three-dimensional model on a client machine.

15. The method of claim 12, wherein the retrieving step comprises retrieving the GIS data via a publicly-accessible global network.

16. A method of operating a network server, the method comprising the steps of:
transferring image data associated with a three-dimensional model of an architectural structure to a client machine,
retrieving GIS data associated with the architectural structure from a GIS database, and
transferring the GIS data to the client machine.

17. The method of claim 16, further comprising the step of receiving from the client machine a user-request indicative of a user-selected portion of the architectural structure.

18. The method of claim 17, wherein the retrieving step is performed in response to receipt of the user-request from the client machine.

19. The method of claim 16, wherein:
the image data transferring step comprises transferring the image data to the client machine via a publicly-accessible global network, and
the GIS data transferring step comprises transferring the GIS data to the client machine via the publicly-accessible global network.

20. The method of claim 16, wherein the retrieving step comprises retrieving the GIS data from the GIS database maintained on a GIS server.

21. The method of claim 17, further comprising the steps of:
generating updated image data indicative of an updated three-dimensional model of the architectural structure based on the retrieved GIS data, and
transferring the updated image data to the client machine.

22. A method of providing GIS data associated with an architectural structure to a user, the method comprising the steps of:
displaying on a client machine a three-dimensional model of the architectural structure to the user,
determining a user-selected portion of the architectural structure when the user operates an input device associated with the client machine,
retrieving via a global network GIS data from a GIS database in response to the determining step, and
displaying to the user on the client machine the GIS data.

23. The method of claim 22, wherein the GIS data displaying step comprises displaying on the client machine an updated three-dimensional model of the architectural structure which includes the retrieved GIS data.

24. A network server, comprising:
a processor, and
a memory device electrically coupled to the processor, the memory device having stored therein a plurality of instructions which, when executed by the processor, cause the processor to:
transfer image data associated with a three-dimensional model of an architectural structure to a client machine,
retrieve GIS data associated with the architectural structure from a GIS database, and
transfer the GIS data to the client machine.

25. The network server of claim 24, wherein the plurality of instructions, when executed by the processor, further cause the processor to communicate with the client machine so as to receive therefrom a user-request indicative of a user-selected portion of the architectural structure.

26. The network server of claim 24, wherein the plurality of instructions, when executed by the processor, further cause the processor to:
communicate with the client machine via a publicly-accessible global network so as to transfer the image data thereto, and
communicate with the client machine via the publicly-accessible global network so as to transfer the GIS data thereto.

27. The network server of claim 24, wherein the plurality of instructions, when executed by the processor, further cause the processor to communicate with a GIS server so as to retrieve the GIS data from the GIS database maintained thereon.

28. The network server of claim 24, wherein the plurality of instructions, when executed by the processor, further cause the processor to:
generate updated image data indicative of an updated three-dimensional model of the architectural structure based on the retrieved GIS data, and
transfer the updated image data to the client machine.

29. An article comprising a computer-readable signal-bearing medium having therein a plurality of instructions which, when executed by a processor, cause the processor to:
communicate with a client machine so as to transfer image data associated with a three-dimensional model of an architectural structure thereto,
retrieve GIS data associated with the architectural structure from a GIS database, and
communicate with the client machine so as to transfer the GIS data thereto.

30. The article of claim 29, wherein the medium is a recordable data storage medium.

31. The article of claim 30, wherein the medium is selected from the group consisting of magnetic, optical, biological, and atomic data storage medium.

32. The article of claim 29, wherein the medium is a modulated carrier signal.

33. The article of claim 29, wherein the plurality of instructions, when executed by the processor, further cause the processor to communicate with the client machine so as to receive therefrom a user-request indicative of a user-selected portion of the architectural structure.

34. The article of claim 29, wherein the plurality of instructions, when executed by the processor, further cause the processor to:
communicate with the client machine via a publicly-accessible global network so as to transfer the image data thereto, and
communicate with the client machine via the publicly-accessible global network so as to transfer the GIS data thereto.

35. The article of claim 29, wherein the plurality of instructions, when executed by the processor, further cause the processor to communicate with a GIS server so as to retrieve the GIS data from the GIS database maintained thereon.

36. The article of claim 29, wherein the plurality of instructions, when executed by the processor, further cause the processor to:
generate updated image data indicative of an updated three-dimensional model of the architectural structure based on the retrieved GIS data, and
transfer the updated image data to the client machine.

37. A network server, comprising:
a processor, and
a memory device electrically coupled to the processor, the memory device having stored therein a plurality of instructions which, when executed by the processor, cause the processor to:
generate a three-dimensional model of an architectural structure,
determine a user-selected portion of the architectural structure, and
retrieve GIS data associated with the user-selected portion of the architectural structure from a GIS database.

38. The network server of claim 37, wherein the plurality of instructions, when executed by the processor, further cause the processor to:
communicate with a client machine so as to display the three-dimensional model of the architectural structure thereon, and
communicate with a GIS server so as to retrieve the GIS data from the GIS database maintained thereon.

39. The network server of claim 37, wherein the plurality of instructions, when executed by the processor, further cause the processor to retrieve the GIS data via a publicly-accessible global network.

40. The network server of claim 37, wherein the plurality of instructions, when executed by the processor, further cause the processor to generate an updated three-dimensional model of the architectural structure that comprises the retrieved GIS data.

41. The network server of claim 37, wherein the plurality of instructions, when executed by the processor, further cause the processor to generate a photorealistic three-dimensional model of the architectural structure.

42. An article comprising a computer-readable signal-bearing medium having therein a plurality of instructions which, when executed by a processor, cause the processor to:
generate a three-dimensional model of an architectural structure,
determine a user-selected portion of the architectural structure, and
retrieve GIS data associated with the user-selected portion of the architectural structure from a GIS database.

43. The article of claim 42, wherein the medium is a recordable data storage medium.

44. The article of claim 43, wherein the medium is selected from the group consisting of magnetic, optical, biological, and atomic data storage medium.

45. The article of claim 42, wherein the medium is a modulated carrier signal.

46. The article of claim 42, wherein the plurality of instructions, when executed by the processor, further cause the processor to retrieve the GIS data via a publicly-accessible global network.

47. The article of claim 42, wherein the plurality of instructions, when executed by the processor, further cause the processor to generate an updated three-dimensional model of the architectural structure that comprises the retrieved GIS data.

48. The article of claim 42, wherein the plurality of instructions, when executed by the processor, further cause the processor to generate a photorealistic three-dimensional model of the architectural structure.
